(19) United States
(12) Patent Application Publication
(10) Pub. No.: US 2020/0124729 A1
(43) Pub. Date: Apr. 23, 2020

(54) LASER DISTANCE MEASURING APPARATUS

(71) Applicant: Mitsubishi Electric Corporation, Tokyo (JP)

(72) Inventors: Shumpei KAMEYAMA, Tokyo (JP); Masaharu Imaki, Tokyo (JP); Yusuke Ito, Tokyo (JP); Takayuki Yanagisawa, Tokyo (JP); Masahiro Kawai, Tokyo (JP); Yosuke Takagawa, Tokyo (JP)

(73) Assignee: Mitsubishi Electric Corporation, Tokyo (JP)

(21) Appl. No.: 16/550,509

(22) Filed: Aug. 26, 2019

(30) Foreign Application Priority Data
Oct. 23, 2018 (JP) 2018-198874

(51) Int. Cl. G01S 17/50; B60W 30/08; G01S 17/93; G01S 7/481; G01S 7/491

(52) U.S. Cl. CPC G01S 17/50; B60W 30/08; G01S 7/4915; G01S 7/481; G01S 17/936

(57) ABSTRACT

To provide a laser distance measuring apparatus which can realize appropriate measurable distance according to the object distance and the moving speed of the moving body, and quick response of distance detection, without complicating the equipment configuration. A laser distance measuring apparatus is provided with a light receiving unit that receives a reflected light of a laser beam reflected by an object, and outputs a light receiving signal; and a distance calculation unit that calculates an object distance which is a distance to the object, based on the emitted laser beam and the light receiving signal, wherein the distance calculation unit changes a light receiving sensitivity of the light receiving signal, based on a moving speed of the moving body and the object distance.

### INCORPORATION BY REFERENCE

The disclosure of Japanese Patent Application No. 2018-198874 filed on Oct. 23, 2018 including its specification, claims and drawings, is incorporated herein by reference in its entirety.

### BACKGROUND

Present disclosure is related with a laser distance measuring apparatus.

Previously, there has been known the laser distance measuring apparatus which irradiates a light beam, such as a laser beam, to the measuring object, and measures the distance to the object, based on the reflected light which is reflected from the object. As such the laser distance measuring apparatus, there is the scanning type laser distance measuring apparatus which scans the laser beam emitted from the beam source in the specific range, by the scanning mechanism. However, many of conventional laser distance measuring apparatuses are operating on a fixed apparatus condition. For example, the pulse laser beam source is difficult to drive emitted light at high power and high frequency, from the viewpoint of the reliability of the laser beam source itself. There is a limit to measure the distance to the long distance measuring object, and there is a limit in the point number obtained in one frame from the starting point to the end point of the scan field. Accordingly, there is a problem that the distance measurement performance, the resolution, the sensitivity, the detection time, and the like are fixed.

In order to solve this problem, in the technology of JP H07-191148 A, the laser beam is irradiated to front of the vehicle, and a plurality of photo detectors receive the reflected lights from respective different directions in the horizontal direction at the same time. Further, a plurality of photo detectors are selected in any combination and the light receiving sensitivity is raised by adding and outputting the light receiving signals outputted from the selected photo detectors.

In the technology of the JP 2015-135272 A, the laser distance measuring apparatus is mounted on the vehicle, and consists of a plurality of photo detectors. About a direction where the light receiving signal is not detected, by increasing the integration frequency of the light receiving signals according to the vehicle speed, SNR (Signal to Noise Ratio) of the light receiving signal is improved, and the light receiving sensitivity is set appropriately.

### SUMMARY

However, there is a following problem in the conventional laser distance measuring apparatuses including the above-mentioned JP H07-191148 A and JP 2015-135272 A. The conventional laser distance measuring apparatus is operating on the certain fixed apparatus condition, and it does not cause problem when necessary SNR is obtained on this condition. However, when the object exists at the long distance and the optical reflectance is low, or when the weather is bad, such as rain or mist, sufficient SNR is not necessarily obtained. In JP H07-191148 A, it is proposed to add the reception signals outputted from a plurality of photo detectors, and raise the light receiving sensitivity. However, there is a problem that cost and size of the apparatus are increased to constitute a plurality of photo detectors.

In the case of the laser distance measuring apparatus which is mounted on the moving body such as the vehicle, and is utilized for safe travel, such as collision prevention to the body (person, other vehicle, obstacle, or the like) which is the measuring object, optimum operation depends on the movement information of the moving body. For example, when the travelling speed is slow such as traveling of the general road, the measuring object becomes the body at the short distance. When the travelling speed is fast such as traveling of the highway, the measuring object becomes the body at the long distance. However, in JP 2015-135272 A, about the direction where the light receiving signal is not detected, the signal integration frequency is increased according to the vehicle speed, and SNR is improved. However, if the integration frequency is increased, the distance measurement rate is reduced in each direction where light is transmitted and received. Accordingly, delay occurs in the detection time of the body at the short distance, and there is a problem that the body which becomes the measuring object cannot be detected in appropriate time.

In view of the foregoing background, it is desired to provide a laser distance measuring apparatus which can realize appropriate measurable distance according to the object distance and the moving speed of the moving body, and quick response of distance detection, without complicating the equipment configuration.

A laser distance measuring apparatus mounted on a moving body according to the present disclosure, including:

a laser beam generating unit that emits a laser beam;

a light receiving unit that receives a reflected light of the laser beam reflected by an object, and outputs a light receiving signal; and

a distance calculation unit that calculates an object distance which is a distance to the object, based on the emitted laser beam and the light receiving signal,

wherein the distance calculation unit changes a light receiving sensitivity of the light receiving signal, based on a moving speed of the moving body and the object distance.

According to the laser distance measuring apparatus of the present disclosure, since the light receiving sensitivity of the light receiving signal is changed based on the object distance and the moving speed of the moving body, it is possible to realize the appropriate measurable distance according to the object distance and the moving speed of the moving body, and the quick response of distance detection can be realized, without complicating the equipment configuration.

### BRIEF DESCRIPTION OF THE DRAWINGS

FIG. 1 is a figure showing the schematic configuration of the laser distance measuring apparatus according to Embodiment 1;

FIG. 2 is a figure showing the schematic diagram of the laser distance measuring apparatus according to Embodiment 1;

FIG. 3 is a figure for explaining the MEMS mirror according to Embodiment 1;

FIG. 4 is a time chart for explaining the driving current of the MEMS mirror according to Embodiment 1;

FIG. 5 is a figure for explaining the irradiation angle range of the up and down direction and the right and left direction according to Embodiment 1;

FIG. 6 is a hardware configuration diagram of the controller according to Embodiment 1;

FIG. 7 is a figure for explaining detection of the distance to the body according to Embodiment 1.

FIG. 8 is a time chart for explaining the beam source signal and the light receiving signal according to Embodiment 1;

FIG. 9 is a figure for explaining the behavior of the light receiving signal when scanning the laser beam right and left according to Embodiment 1;

FIG. 10 is a time chart for explaining the behavior of the light receiving signal according to a comparative example;

FIG. 11 is a time chart for explaining the integration behavior of the light receiving signal according to Embodiment 1;

FIG. 12 is a figure for explaining the setting data of the processing frequency according to Embodiment 1;

FIG. 13 is a time chart for explaining the time shift of the light receiving signal according to Embodiment 1;

FIG. 14 is a time chart for explaining the time shift of the light receiving signal according to Embodiment 1;

FIG. 15 is a circuit diagram for explaining the gain change circuit according to Embodiment 2;

FIG. 16 is a figure for explaining the setting data of the conversion gain and the pulse width according to Embodiment 2;

FIG. 17 is a time chart for explaining the behavior of the light receiving signal according to Embodiment 2; and

FIG. 18 is a time chart for explaining the behavior of the light receiving signal according to Embodiment 2.

### DETAILED DESCRIPTION OF THE EMBODIMENTS

### 1. Embodiment 1

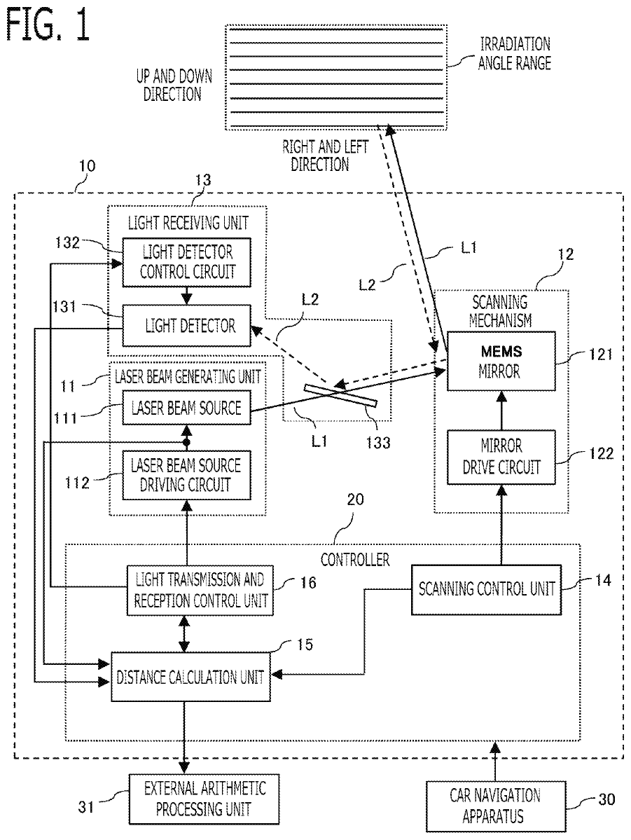

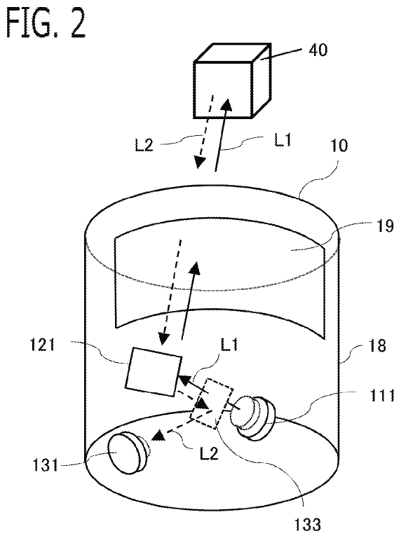

A laser distance measuring apparatus 10 according to Embodiment 1 will be explained with reference to drawings. FIG. 1 is a block diagram showing the schematic configuration of the laser distance measuring apparatus 10. FIG. 2 is a schematic diagram showing the schematic arrangement and configuration of the optical system of the laser distance measuring apparatus 10. The laser distance measuring apparatus 10 is also called LiDAR (Light Detection and Ranging) or laser radar. The laser distance measuring apparatus 10 is mounted on a vehicle as a moving body, irradiates a laser beam L1 to front of the moving body by two-dimensional scan, and measures a distance to the object, which exists in front of the moving body, from the laser distance measuring apparatus 10 (the moving body).

The laser distance measuring apparatus 10 is provided with a laser beam generating unit 11, a scanning mechanism 12, a light receiving unit 13, a scanning control unit 14, a distance calculation unit 15, and the like. As described later, the controller 20 is provided with the scanning control unit 14, and the distance calculation unit 15. The laser beam generating unit 11 emits the laser beam L1. The scanning mechanism 12 is a mechanism which changes the irradiation angle of the laser beam L1. The scanning control unit 14 controls the scanning mechanism 12, and scans the irradiation angle of the laser beam periodically. The light receiving unit 13 receives a reflected light L2 of the laser beam reflected by the object, and outputs a light receiving signal. The distance calculation unit 15 calculates an object distance which is a distance to the object, based on the emitted laser beam L1 and the light receiving signal.

### 1-1. Laser Beam Generating Unit 11

The laser beam generating unit 11 emits the laser beam L1. The laser beam generating unit 11 is provided with a laser beam source 111 and a laser beam source driving circuit 112. The laser beam source driving circuit 112 generates a pulse form output signal (beam source signal) which is turned ON at a pulse cycle Tp, as shown in FIG. 8. The laser beam source driving circuit 112 generates the pulse form output signal, based on a command signal from a light transmission and reception control unit 16 described below. When the output signal transmitted from the laser beam source driving circuit 112 is turned ON, the laser beam source 111 generates the laser beam L1 of near infrared wavelength, and emits it toward the scanning mechanism 12. The laser beam L1 emitted from the laser beam source 111 transmits a collection mirror 133 disposed between the laser beam source 111 and the scanning mechanism 12.

### 1-2. Scanning Mechanism 12

The scanning mechanism 12 changes the irradiation angle of the laser beam L1. In the present embodiment, the scanning mechanism 12 changes an irradiation angle of the laser beam L1, which is irradiated to front of the moving body, to a right and left direction and an up and down direction with respect to a traveling direction (an irradiation center line) of the moving body. The scanning mechanism 12 is provided with a movable mirror 121 and a mirror drive circuit 122. As shown in FIG. 2, the laser beam L1 emitted from the laser beam source 111 transmits the collection mirror 133 and is reflected by the movable mirror 121, and then it transmits the transmission window 19 provided in the housing 9 and is irradiated to front of the moving body at an irradiation angle according to angle of the movable mirror 121.

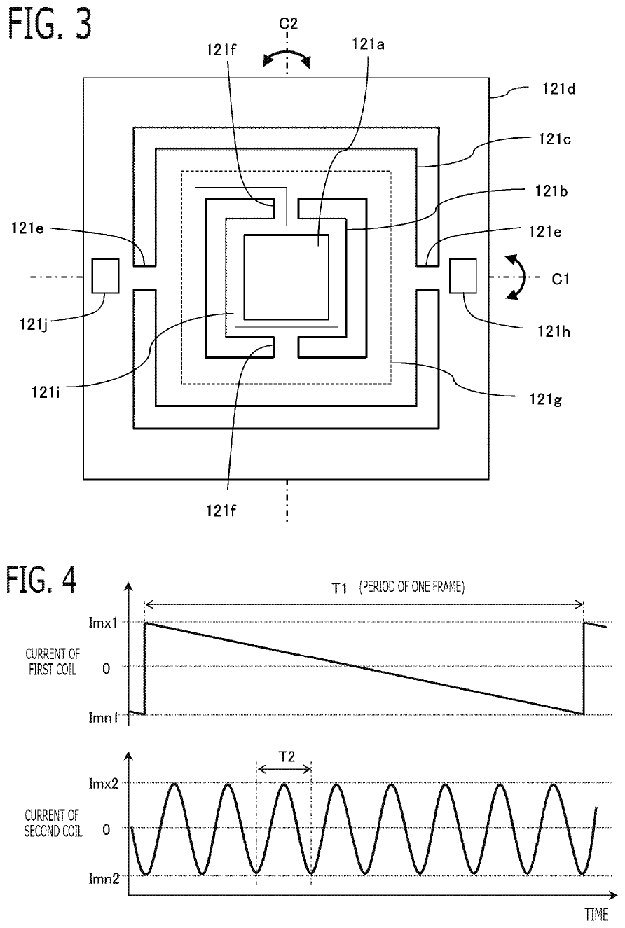

In the present embodiment, the movable mirror 121 is a MEMS mirror 121 (Micro Electro Mechanical Systems). As shown in FIG. 3, the MEMS mirror 121 is provided with a rolling mechanism which rotates a mirror 121a around a first axis C1 and a second axis C2 which are orthogonal to each other. The MEMS mirror 121 is provided with an inner frame 121b of a rectangular plate shape which is provided with the mirror 121a, an intermediate frame 121c of a rectangular ring plate shape disposed outside the inner frame 121b, and an outer frame 121d of a rectangular plate shape disposed outside the intermediate frame 121c. The outer frame 121d is fixed to a body of the MEMS mirror 121.

The outer frame 121d and the intermediate frame 121c are connected by right and left two first torsion bars 121e which have torsional elasticity. The intermediate frame 121c is twisted around a first axis C1 which connects the two first torsion bars 121e, with respect to the outer frame 121d. When twisted around the first axis C1 to one side or the other side, the irradiation angle of the laser beam L1 changes to the up side or the down side. The intermediate frame 121c and the inner frame 121b are connected by up and down two second torsion bars 121f which have elasticity. The inner frame 121b is twisted around a second axis C2 which connects the two second torsion bars 121f, with respect to the intermediate frame 121c. When twisted around the second axis C2 to one side or the other side, the irradiation angle of the laser beam L1 changes to the left side or the right side.

An annular first coil 121g along the frame is provided in the intermediate frame 121c. A first electrode pad 121h connected to the first coil 121g is provided in the outer frame 121d. An annular second coil 121i along the frame is provided in the inner frame 121b. A second electrode pad 121j connected to the second coil 121i is provided in the outer frame 121d. A permanent magnet (not shown) is provided in the MEMS mirror 121. When a positive or negative current flows into the first coil 121g, the Lorentz force which twists the intermediate frame 121c around the first axis C1 to one side or the other side occurs. And, the torsional angle is proportional to the magnitude of current. When a positive or negative current flows into the second coil 121i, the Lorentz force which twists the inner frame 121b around the second axis C2 to one side or the other side occurs. And, the torsional angle is proportional to the magnitude of current.

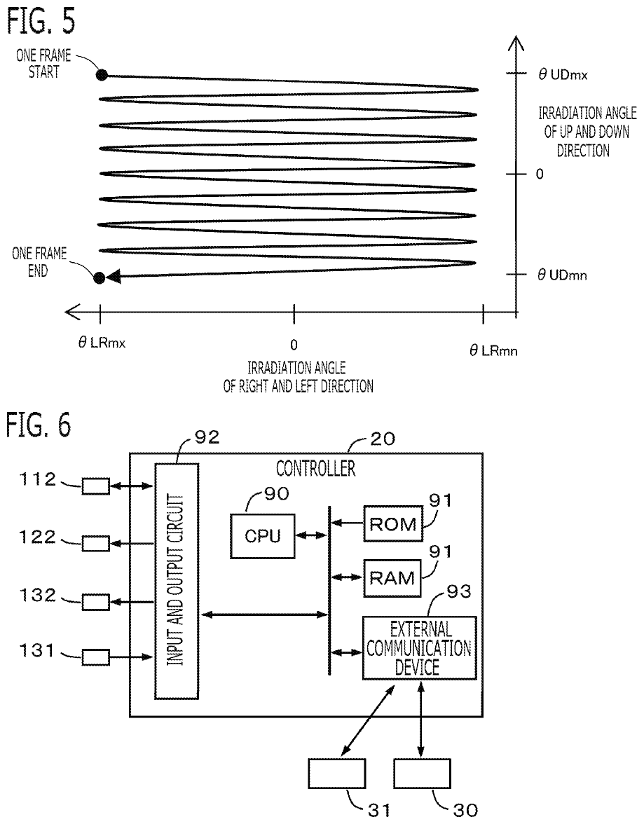

As shown in the upper row time chart of FIG. 4, the mirror drive circuit 122 supplies a current, which oscillates between a positive first maximum current value Imx1 and a negative first minimum current value Imn1 at a first period T1, to the first coil 121g via the first electrode pad 121h, according to the command signal of the scanning control unit 14. The first period T1 is a period for one frame of the two-dimensional scan. The vibration waveform of current is a saw tooth wave, a triangular wave, or the like. As shown in FIG. 5, the laser beam oscillates between a maximum irradiation angle θUDmx of the up and down direction corresponding to the positive first maximum current value Imx1, and a minimum irradiation angle θUDmn of the up and down direction corresponding to the negative first minimum current value Imn1 at the first period T1. The first maximum current value Imx1 and the first minimum current value Imn1 may be changed according to the operating condition.

As shown in the lower row graph of FIG. 4, the mirror drive circuit 122 supplies a current, which oscillates between a positive second maximum current value Imx2 and a negative second minimum current value Imn2 at a second period T2, to the second coil 121i via the second electrode pad 121j, according to the command signal of the scanning control unit 14. The second period T2 is set to a value shorter than the first period T1, and is set to a value obtained by dividing the first period T1 by a reciprocation scanning frequency of the right and left direction in one frame. The vibration waveform of current is a sine wave, a rectangular wave, or the like. As shown in FIG. 5, the laser beam oscillates between a maximum irradiation angle θLRmx of the right and left direction corresponding to the positive second maximum current value Imx2, and a minimum irradiation angle θLRmn of the right and left direction corresponding to the negative second minimum current value Imn2 at the second period T2. The second maximum current value Imx2 and the second minimum current value Imn2 may be changed according to the operating condition.

### 1-3. Light Receiving Unit 13

The light receiving unit 13 receives a reflected light L2 of the laser beam reflected by the object in front of the moving body, and outputs a light receiving signal. The light receiving unit 13 is provided with a light detector 131, a light detector control circuit 132, and a collection mirror 133. As shown in FIG. 2, the reflected light L2 reflected by the object 40 in front of the moving body transmits the transmission window 19 and is reflected by the movable mirror 121, and then it is reflected by the collection mirror 133 and enters the light detector 131.

The light detector 131 is provided with APD (Avalanche Photo Diode) and the like as a photo detector, and outputs the light receiving signal according to the received reflected light L2. The light detector control circuit 132 controls operation of the light detector 131, based on the command signal from the light transmission and reception control unit 16. The light receiving signal outputted from the light detector 131 is inputted into the controller (the distance calculation unit 15).

### 1-4. Controller 20

The laser distance measuring apparatus 10 is provided with a controller 20. The controller 20 is provided with functional parts such as the scanning control unit 14, the distance calculation unit 15, the light transmission and reception control unit 16, and the like. Each function of the controller 20 is realized by processing circuits provided in the controller 20. Specifically, as shown in FIG. 6, the controller 20 is provided, as processing circuits, with an arithmetic processor (computer) 90 such as a CPU (Central Processing Unit), storage apparatuses 91 which exchange data with the arithmetic processor 90, an input and output circuit 92 which inputs and outputs external signals to the arithmetic processor 90, an external communication device 93 which performs data communication with external apparatus of the laser distance measuring apparatus 10, and the like.

As the arithmetic processor 90, ASIC (Application Specific Integrated Circuit), IC (Integrated Circuit), DSP (Digital Signal Processor), FPGA (Field Programmable Gate Array), various kinds of logical circuits, various kinds of signal processing circuits, and the like may be provided. As the arithmetic processor 90, a plurality of the same type ones or the different type ones may be provided, and each processing may be shared and executed. As the storage apparatuses 91, there are provided a RAM (Random Access Memory) which can read data and write data from the arithmetic processor 90, a ROM (Read Only Memory) which can read data from the arithmetic processor 90, and the like. As the storage apparatuses 91, various kinds of storage apparatus, such as a flash memory and EEPROM (Electrically Erasable Programmable Read Only Memory) may be used.

The input and output circuit 92 is connected to the laser beam source driving circuit 112, the mirror drive circuit 122, the light detector 131, the light detector control circuit 132, and the like; and is provided with a communication circuit which performs transmission and reception of data and a control command between these and the arithmetic processor 90, an A/D converter, a D/A converter, an input/output port, and the like. The input and output circuit 92 is provided with an arithmetic processor which controls each circuit. The external communication device 93 communicates with external apparatuses such as a car navigation apparatus 30 and an external arithmetic processing unit 31.

Then, the arithmetic processor 90 runs software items (programs) stored in the storage apparatus 91 such as a ROM and collaborates with other hardware devices in the controller 20, such as the storage apparatus 91, the input and output circuit 92, and the external communication device 93, so that the respective functions of the functional parts 14 to 16 included in the controller 20 are realized. Setting data items such as a processing frequency to be utilized in the functional parts 14 to 16 are stored, as part of software items (programs), in the storage apparatus 91 such as a ROM. Each function of the controller 20 will be described in detail below.

### <Light Transmission and Reception Control Unit 16>

The light transmission and reception control unit 16 transmits a command signal to the laser beam source driving circuit 112 so as to output a pulse form laser beam which has a pulse width at the pulse cycle Tp. The light transmission and reception control unit 16 transmits a command signal to the light detector control circuit 132 so as to output a light receiving signal from the light detector 131.

### <Scanning Control Unit 14>

The scanning control unit 14 controls the scanning mechanism 12 to scan the irradiation angle of the laser beam. In the present embodiment, the scanning control unit 14 controls the scanning mechanism 12 to performs a two-dimensional scan which scans the laser beam L1 in an irradiation angle range of the right and left direction with respect to the traveling direction of the moving body, and scans the laser beam L1 in an irradiation angle range of the up and down direction with respect to the traveling direction of the moving body.

The scanning control unit 14 transmits the command signal to scan the irradiation angle of the laser beam in the irradiation angle range of the up and down direction at the first period T1, to the mirror drive circuit 122. Specifically, the scanning control unit 14 transmits the command signal of the positive first maximum current value Imx1 and the negative first minimum current value Imn1 of the current supplied to the first coil 121g, and the first period T1, to the mirror drive circuit 122.

And, the scanning control unit 14 transmits the command signal to scan the irradiation angle of the laser beam in the irradiation angle range of the right and left direction at the second period T2, to the mirror drive circuit 122. Specifically, the scanning control unit 14 transmits the command signal of the positive second maximum current value Imx2 and the negative second minimum current value Imn2 of the current supplied to the second coil 121i, and the second period T2, to the mirror drive circuit 122. The scanning control unit 14 sets a value obtained by dividing the first period T1 by the reciprocation scanning frequency of the right and left direction in one frame, to the second period T2.

As shown in FIG. 5, the irradiation angle of the laser beam L1 is scanned once in the two-dimensional scan field of rectangular shape at the first period T1. This one scan of the two-dimensional scan field is called as one frame.

### <Distance Calculation Unit 15>

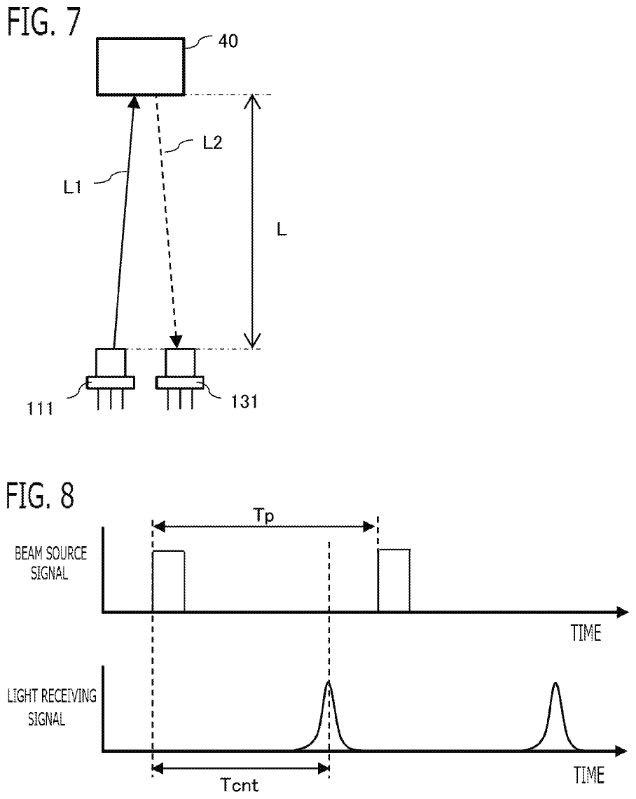

The distance calculation unit 15 calculates a distance to the object which exists at the irradiation angle, based on the emitted laser beam and the light receiving signal. As shown in FIG. 7, the laser beam L1 emitted from the laser beam source 111 is reflected by the object 40 which exists ahead by a distance L, and the reflected light L2 enters into the light detector 131 which exists backward by the distance L. FIG. 8 shows the relationship between the beam source signal of the laser beam L1 emitted from the laser beam source iii, and the light receiving signal of the reflected light L2 received by the light detector 131. The time Tcnt from the rising of the beam source signal to the peak of the light receiving signal is time for the laser beam to go and return the distance L between the laser beam source 111 and the light detector 131, and the object 40. Therefore, the distance L to the object 40 can be calculated by multiplying the velocity of light to the time Tcnt, and dividing by 2.

The output signal (beam source signal) from the laser beam source driving circuit 112 to the laser beam source 111 is inputted into the distance calculation unit 15. The distance calculation unit 15 can detect a time point when the laser beam generating unit 11 starts to emit the pulse form laser beam. The distance calculation unit 15 measures, as a light receiving time, a time Tcnt from a time point when the laser beam generating unit 11 starts to emit the laser beam to a time point when the light receiving unit 13 outputs the light receiving signal. Then, the distance calculation unit 15 calculates a value obtained by multiplying the velocity of light c0 to the light receiving time Tcnt, and dividing by 2, as the distance L to the object which exists at the irradiation angle when emitting the laser beam (L−Tcnt×c0/2). When the light receiving unit 13 is not outputting the light receiving signal, the distance calculation unit 15 determines that the object which exists at the irradiation angle at that time cannot be detected, and does not calculate the distance L. The distance calculation unit 15 transmits the calculating result of distance to the external arithmetic processing unit 31.

### <Problem of Intensity of Light Receiving Signal>

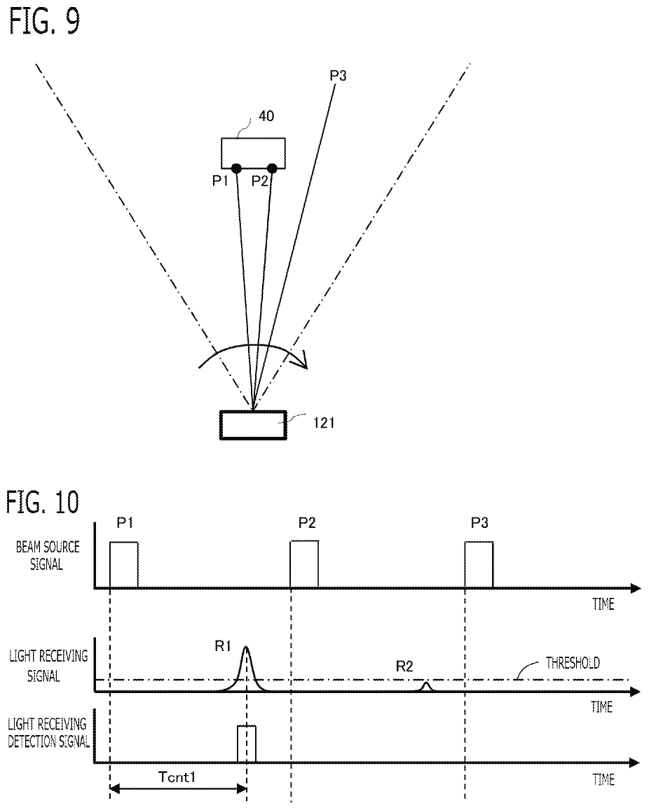

FIG. 9 shows each irradiation angle P1, P2, P3 when the irradiation angle of the laser beam is scanned from the left to the right. At the each irradiation angle P1, P2, a black dot shows a part where the laser beam hits the object 40. With a laser distance measuring apparatus according to a comparative example, as shown in FIG. 10, a pulse form laser beam is emitted at the time point of the each irradiation angle P1, P2, P3; and at the each irradiation angle P1, P2, a reflected light reflected by the object 40 enters into the light detector 131, and a light receiving signal R1, R2 is outputted. Since the light receiving signal R1 is over a threshold value, a pulse form light receiving detection signal is outputted. However, since signal peak of the light receiving signal R2 is low and the light receiving signal R2 is not over the threshold value, the light receiving detection signal is not outputted. Accordingly, distance cannot be measured.

Such a phenomenon in which the peak of the light receiving signal drops is caused by the laser beam hitting rain or mist during the laser beam goes and returns, and the light being scattered, in a case of bad weather, such as rain or mist. There is also a case where the laser beam hits dust which floats in air, and light is scattered. Since the hitting to rain, mist, or dust occurs irregularly, it is difficult to estimate. As the object becomes far, the hitting probability to rain, mist, or dust becomes high, and the frequency of the phenomenon in which the peak of the light receiving signal drops becomes high.

### <Change of Light Receiving Sensitivity>

In the present embodiment, the distance calculation unit 15 changes a light receiving sensitivity of the light receiving signal, based on a moving speed of the moving body and the object distance. The distance calculation unit 15 changes a processing frequency of the light receiving signals which are measured in this time and the past and used for calculation of the object distance, based on the object distance and the moving speed of the moving body.

Specifically, the distance calculation unit 15 calculates an integration value of the processing frequency of the light receiving signals which are measured in scanning periods (frames) of this time and the past at the same irradiation angle as this time, and calculates the object distance based on the integration value of the light receiving signals.

The distance calculation unit 15 stores a time waveform of the light receiving signal measured at each irradiation angle, to the storage apparatus 91, such as RAM. In time of the time waveform, the emission starting time point of the laser beam (rising time point of the beam source signal) is set to 0. Then, the distance calculation unit 15 integrates the processing frequency of the time waveforms of the light receiving signal which are measured in the scanning periods (frames) of this time and the past at the same irradiation angle as this time, and calculates the object distance based on the time waveform of the integration value of the light receiving signals.

Specifically, at the each irradiation angles, the distance calculation unit 15 stores A/D conversion values of the light receiving signal in a period from the emission starting time point of the laser beam to the next emission starting time point, to the storage apparatus 91 such as RAM, by correlating with time information whose time 0 is set to the emission starting time point. Then, the distance calculation unit 15 reads the time waveforms of the light receiving signal of this time and the past for integrating, from the storage apparatus 91; integrates, at each time, the light receiving signals of this time and the past; and calculates the time waveform of the integration value which consists of the integration value at each time. The distance calculation unit 15 determines time when the integration value of the light receiving signals exceeded the threshold value using the time waveform of the integration value of the light receiving signals, and calculates the determined time as the light receiving time Tcnt.

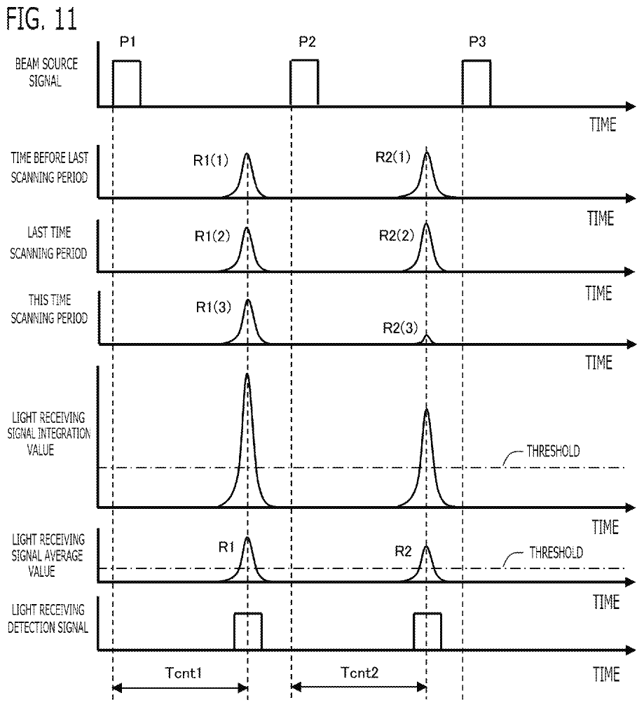

FIG. 11 shows a behavior when the processing frequency is set to 3. About the irradiation angle P1, the light receiving signal R1 (3) of this time scanning period (frame), the light receiving signal R1 (2) of the last time scanning period (frame), and the light receiving signal R1 (1) of the time before last scanning period (frame) are integrated, and the integration value of the light receiving signals is calculated. About the irradiation angle P2, the light receiving signal R2 (3) of this time scanning period (frame), the light receiving signal R2 (2) of the last time scanning period (frame), and the light receiving signal R2 (1) of the time before last scanning period (frame) are integrated, and the integration value of the light receiving signals is calculated. Although the peak of the light receiving signal R2 (3) of this time scanning period is low, since the normal past light receiving signals are also integrated, the decline of the integration value is suppressed.

The distance calculation unit 15 turns ON the light receiving detection signal, when the integration value of the light receiving signals exceeds a threshold value for integration value. The distance calculation unit 15 measures time from the time point when the driving signal from the laser beam source driving circuit 112 to the laser beam source 111 is turned ON, to the time point when the light receiving detection signal is turned ON; and calculates the measured time as the light receiving time Tcnt.

The distance calculation unit 15 may calculate an average value of the light receiving signals by dividing the integration value of the light receiving signals by the processing frequency, and may turn ON the light receiving detection signal when the average value of the light receiving signals exceeds a threshold value for average value. That is to say, the distance calculation unit 15 may calculate the average value of the processing frequency of the light receiving signals which are measured in scanning periods (frames) of this time and the past at the same irradiation angle as this time, and may calculate the object distance based on the average value of the light receiving signals.

### <Setting of Processing Frequency>

Next, the setting of the processing frequency will be explained. As the objective distance becomes far, the intensity of the laser beam which is irradiated to the object drops due to spread of the laser beam, and the frequency at which the light is scattered increases due to rain, mist, or dust in air, and then the light receiving intensity drops. Accordingly, as the objective distance becomes far, it is required to increase the processing frequency and enhance the light receiving sensitivity. On the other hand, as the moving speed of the moving body becomes large, it is required to decrease the processing frequency, and detect without time lag (in real time), from a viewpoint of collision prevention.

Then, the distance calculation unit 15 changes the processing frequency of the light receiving signal, based on the moving speed of the moving body and the object distance. The distance calculation unit 15 increases the processing frequency as the object distance becomes large, and decreases the processing frequency as the moving speed of the moving body becomes large.

In this case, the distance calculation unit 15 uses the object distance measured in the past. The distance calculation unit 15 uses the object distance measured in the last time scanning period (frame) at the same irradiation angle as this time, for example. The distance calculation unit 15 obtains the information on the moving speed of the moving body from the car navigation apparatus 30, the controller of vehicle, or the like.

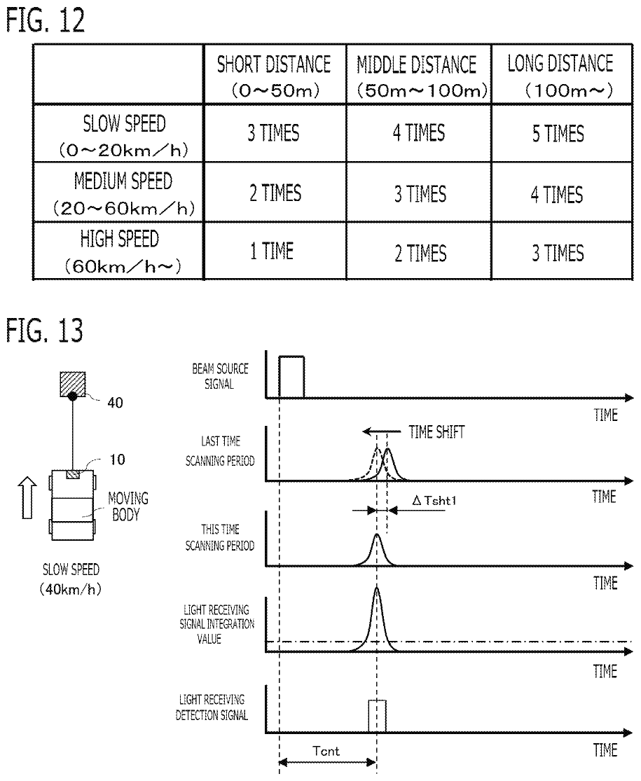

FIG. 12 shows an example of setting data of the processing frequency. In FIG. 12, the moving speed of the moving body is divided into three regions of slow speed (0 to 20 km/h), medium speed (20 to 60 km/h), and high speed (larger than or equal to 60 km/h), and the object distance is divided into three regions of short distance (0 to 50 m), middle distance (50 m to 100 m), and long distance (longer than or equal to 100 m). That is to say, it is divided into a matrix form region of 3×3, and the processing frequency is set in each region.

As shown in this figure, at the slow speed, as the object distance increases in order of the short distance, the middle distance, and the long distance, the processing frequency is increased in order of 3 times, 4 times, and 5 times. At the medium speed, as the object distance increases in order of the short distance, the middle distance, and the long distance, the processing frequency is increased in order of 2 times, 3 times, and 4 times. At the high speed, as the object distance increases in order of the short distance, the middle distance, and the long distance, the processing frequency is increased in order of 1 time, 2 times, and 3 times. On the other hand, at the short distance, the moving speed increases in order of the slow speed, the medium speed, and the high speed, the processing frequency is decreased in order of 3 times, 2 times, and 1 time. Similarly, at the medium distance, the moving speed increases in order of the slow speed, the medium speed, and the high speed, the processing frequency is decreased in order of 4 times, 3 times, and 2 times. At the long distance, the moving speed increases in order of the slow speed, the medium speed, and the high speed, the processing frequency is decreased in order of 5 times, 4 times, and 3 times.

### <Integration Method Considering Moving Speed>

When the moving body is traveling, the object distance is changed by moving of the moving body between the measurement time point of the past light receiving signal and the measurement time point of this time light receiving signal. Accordingly, as shown in FIG. 13, the time waveform of the light receiving signal shifts by time corresponding to change of the object distance between the past measurement time point and this time measurement time point. Although it also depends on the scanning period and the moving speed, if the time waveforms of the light receiving signal of this time and the past are integrated as it is, deviation of the time shift causes.

Then, the distance calculation unit 15 shifts time of the light receiving signal measured in the past, by time corresponding to the object distance changed by moving of the moving body, and calculates the integration value of the light receiving signals using the past light receiving signal whose time was shifted.

For example, the distance calculation unit 15 calculates a measuring time difference ΔTm between this time measurement time point and the past measurement time point. The distance calculation unit 15 sets the first period T1 mentioned above to the measuring time difference ΔTm (ΔTm=T1) in the case of the measurement time point of the last time scanning period (frame); and sets a double value of the first period T1 mentioned above to the measuring time difference ΔTm (ΔTm=2×T1) in the case of the measurement time point of the time before last scanning period (frame).

Then, the distance calculation unit 15 calculates a shifting time ΔTsht using the next equation. Herein, Vs is the moving speed of the moving body.

ΔTsht=ΔTm×Vs/c0×2 (1)

Then, the distance calculation unit 15 shifts time of the time waveform by subtracting the shifting time ΔTsht from each time of the time waveform of the past light receiving signal. The distance calculation unit 15 integrates, at each time after performing the time shift, the light receiving signals of this time and the past, and calculates the time waveform of the integration value which consists of the integration value at each time.

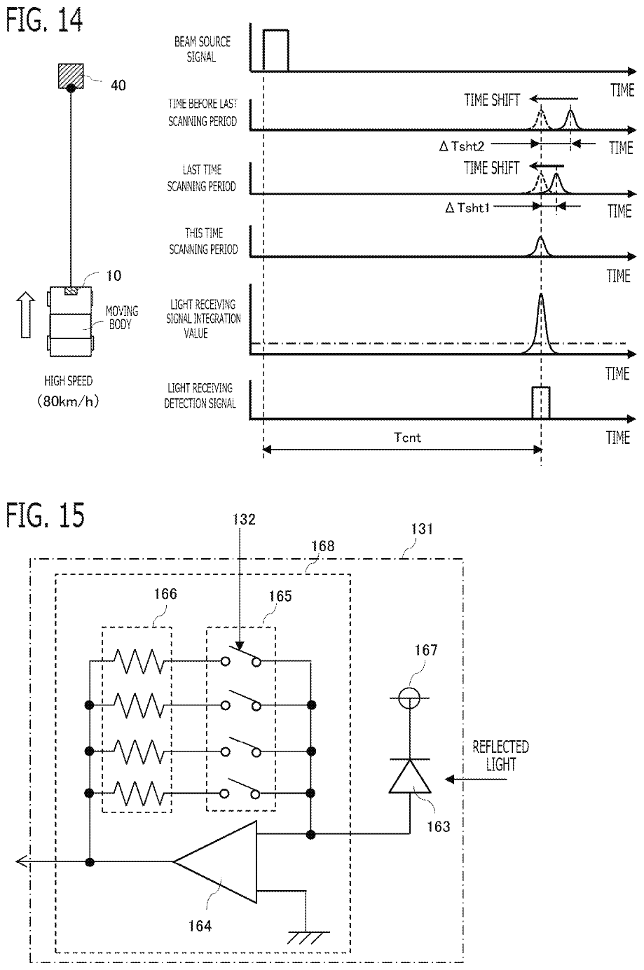

Next, an example of integration behavior of the light receiving signal will be explained. FIG. 13 shows an example of the case where the moving body is approaching the object which exists ahead by 40 m, at moving speed 40 km/hr. FIG. 14 shows an example of the case where the moving body is approaching the object which exists ahead by 120 m, at moving speed 80 km/hr.

In the case of FIG. 13, the processing frequency is set to 2 times, according to the setting data of the processing frequency of FIG. 12. In the example of FIG. 13, the time waveform of the light receiving signal measured in the last time scanning period (frame) is shifted by time ΔTsht1 corresponding to change of the object distance due to the measuring time difference, with respect to the time waveform of this time scanning period. However, since the time of the time waveform of the last time scanning period is subtracted by the shifting time ΔTsht1, the shift with respect to the time waveform of this time scanning period is canceled. Therefore, the integration value of the light receiving signals is calculated with good accuracy.

In the case of FIG. 14, the processing frequency is set to 3 times, according to the setting data of the processing frequency of FIG. 12. In the example of FIG. 14, the time waveform of the light receiving signal measured in the time before last scanning period (frame) is shifted by the shifting time ΔTsht2 which is a double value of the shifting time ΔTsht1 of the last time scanning period, with respect to the time waveform of this time scanning period. However, since the time of the time waveform of the time before last scanning period is also subtracted by the shifting time ΔTsht2, the shift with respect to the time waveform of this time scanning period is canceled. Therefore, the integration value of the light receiving signals is calculated with good accuracy.

In the case of FIG. 14, since the objective distance is further than the case of FIG. 13, the intensity of the light receiving signals are dropping. But, since the processing frequency is set to 3 times which is more than the case of FIG. 13, and the time shift of the past light receiving signals are corrected, detectability of the object can be improved.

### <Example of Conversion>

In the embodiment mentioned above, there has been explained the case where the integration value or the average value of the light receiving signals of this time and the past is calculated. However, the distance calculation unit 15 may calculates a maximum value of the processing frequency of the light receiving signals which are measured in scanning periods of this time and the past at the same irradiation angle as this time, and may calculate the object distance based on the maximum value of the light receiving signals.

In this case, the distance calculation unit 15 selects the maximum value of the light receiving signals at each time, among the processing frequency of the time waveforms of the light receiving signal of this time and the past, and calculates the time waveform of the maximum value which consists of the maximum value at each time. The distance calculation unit 15 determines time when the maximum value of the light receiving signals exceeded a threshold value, using the time waveform of the maximum value of the light receiving signals, and calculates the determined time as the light receiving time Tcnt.

Alternatively, in the embodiment mentioned above, there has been explained the case where integration, averaging, or selection of the maximum value of the time waveforms of the light receiving signal is performed. However, integration, averaging, and selection of the maximum value may not be performed. The distance calculation unit 15 may measure the light receiving time based on the light receiving signal at each irradiation angle, and may calculate an average value of the processing frequency of the light receiving times measured in the scanning period of this time and the past at the same irradiation angle as this time. In this case, since there is a case where the light receiving signal is weak, and the light receiving time is not calculated, the light receiving times are averaged excluding a time when the light receiving time is not calculated. Correction subtracting the shifting time ΔTsht mentioned above may be performed to the past light receiving time, after that, averaging may be performed.

### 2. Embodiment 2

Next, the laser distance measuring apparatus 10 according to Embodiment 2 will be explained. The explanation for constituent parts the same as those in Embodiment 1 will be omitted. The basic configuration of the laser distance measuring apparatus 10 according to the present embodiment is the same as that of Embodiment 1; however, Embodiment 2 is different from Embodiment 1 in a changing method of the light receiving sensitivity of the light receiving signal.

In the present embodiment, as shown in FIG. 15, the light receiving unit 13 (the light detector 131) has a gain change circuit 168 which changes a conversion gain from the output signal of the photo detector 163 to the light receiving signal. The light detector 131 is provided with a current-voltage conversion amplifier 168 (Transfer Impedance Amplifier: TIA) with a gain switching function. In order to operate the photo detector 163 which is APD, the power source 167 is connected, and the photo detector 163 converts the received reflected light into current. The converted current flows into the negative input side of the operational amplifier 164 which is configured in the negative feedback amplifying circuit, and is converted into voltage via the feedback resister 166. A plurality of feedback resisters 166 (in this example, four) are connected in parallel. The switch 165 is connected to each feedback resister 166 in series. ON/OFF of operation of each feedback resister 166 is switched by ON/OFF of each switch 165. By turning each switch 165 on or off by the signal from the light detector control circuit 132, the resistance value of the whole feedback resisters 166 is changed, and the conversion gain when current is converted into voltage is changed. As the resistance value of the whole feedback resisters 166 becomes large, the conversion gain becomes large and the light receiving sensitivity is increased.

Next, the setting method of the conversion gain of TIA and the pulse width of the laser beam will be explained. When the moving speed of the moving body is high-speed, the detection performance of a further distance object becomes important from a viewpoint of collision prevention. However, as the objective distance becomes far, the intensity of the laser beam which is irradiated to the object drops due to spread of the laser beam, and the frequency at which the light is scattered increases due to rain, mist, or dust in air, and then the light receiving intensity drops. Accordingly, as the objective distance becomes far, it is required to enhance the light receiving sensitivity. In order to meet this requirement, in the present embodiment, the light receiving signal is enlarged by enlarging the conversion gain of TIA in the light detector 131, and correcting the dropped light receiving intensity. By enlarging the pulse width of the laser beam, the light intensity of emitted light becomes large and the light receiving signal becomes large.

The distance calculation unit 15 changes the conversion gain of TIA, based on the object distance and the moving speed of the moving body. The distance calculation unit 15 calculates ON/OFF command of each switch 165, and transmits the ON/OFF command to the light detector control circuit 132. The light detector control circuit 132 turns each switch 165 on or off according to the transmitted ON/OFF command.

The distance calculation unit 15 increases the conversion gain of TIA as the object distance becomes large, and increases the conversion gain of TIA as the moving speed of the moving body becomes large.

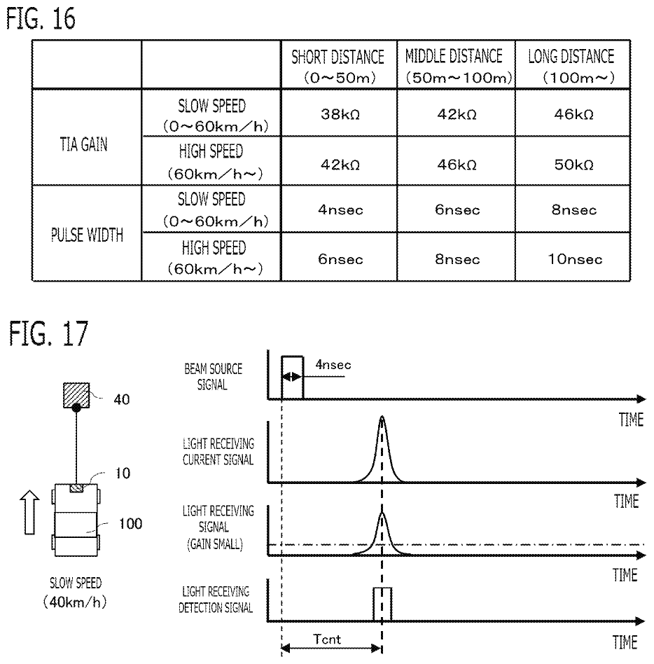

FIG. 16 shows an example of setting data of the conversion gain. In FIG. 16, the moving speed of the moving body is divided into two regions of slow speed (0 km/h to 60 km/h) and high speed (larger than or equal to 60 km/h), and the object distance is divided into three regions of short distance (0 to 50 m), middle distance (50 m to 100 m), and long distance (longer than or equal to 100 m). That is to say, it is divided into the matrix form region of 2×3, and the ON/OFF command of each switch 165 (the resistance value of the whole feedback resisters 166 is shown in the figure) is set in each region.

As shown in this figure, at the slow speed, as the object distance increases in order of the short distance, the middle distance, and the long distance, the conversion gain is increased in order of 38 kΩ, 42 kΩ, and 46 kΩ. At the high speed, as the object distance increases in order of the short distance, the middle distance, and the long distance, the conversion gain is increased in order of 42 kΩ, 46 kΩ, and 50 kΩ. On the other hand, at the short distance, the moving speed increases in order of the slow speed, and the high speed, the conversion gain is increased in order of 38 kΩ and 42 kΩ. Similarly, at the medium distance, the moving speed increases in order of the slow speed, and the high speed, the conversion gain is increased in order of 42 kΩ and 46 kΩ. At the long distance, the moving speed increases in order of the slow speed, and the high speed, the conversion gain is increased in order of 46 kΩ and 50 kΩ.

The distance calculation unit 15 changes the pulse width of the laser beam emitted from the laser beam generating unit 11 (the laser beam source 111), based on the object distance and the moving speed of the moving body. The distance calculation unit 15 transmits a command value of the pulse width to the laser beam source driving circuit 112. The laser beam source driving circuit 112 drives the laser beam source 111 according to the transmitted command value of the pulse width.

The distance calculation unit 15 increases the pulse width as the object distance becomes large, and increases the pulse width as the moving speed of the moving body becomes large.

FIG. 16 shows an example of setting data of the pulse width. At the slow speed, as the object distance increases in order of the short distance, the middle distance, and the long distance, the pulse width is increased in order of 4 nsec, 6 nsec, and 8 nsec. At the high speed, as the object distance increases in order of the short distance, the middle distance, and the long distance, the pulse width is increased in order of 6 nsec, 8 nsec, and 10 nsec. On the other hand, at the short distance, the moving speed increases in order of the slow speed, and the high speed, the pulse width is increased in order of 4 nsec and 6 nsec. Similarly, at the medium distance, the moving speed increases in order of the slow speed, and the high speed, the pulse width is increased in order of 6 nsec and 8 nsec. At the long distance, the moving speed increases in order of the slow speed, the medium speed, and the high speed, the pulse width is increased in order of 8 nsec and 10 nsec.

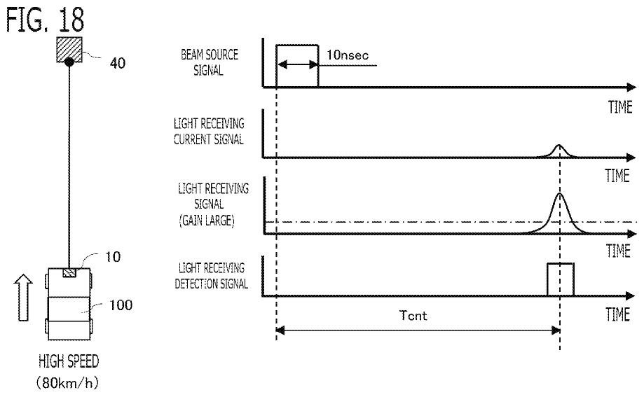

Next, an example of control behavior will be explained. FIG. 17 shows an example of the case where the moving body is approaching the object which exists ahead by 40 m, at moving speed 40 km/hr. FIG. 18 shows an example of the case where the moving body is approaching the object which exists ahead by 120 m, at moving speed 80 km/hr.

In the case of FIG. 17, according to the setting data of FIG. 16, the conversion gain is set to 38 kΩ, and the pulse width is set to 4 ns. Accordingly, the light intensity of emitted light is reduced by reducing the pulse width of the laser beam, and further the conversion gain of TIA is reduced. However, since the object exists at the short distance, the light receiving signal becomes an appropriate level, the light receiving signal exceeds the threshold, and the light receiving time Tcnt can be measured.

Herein, the pulse width of the laser beam and the conversion gain of TIA are reduced, and the light receiving sensitivity is reduced, because the output of TIA may be saturated if the pulse width and the conversion gain are large since the light intensity of the reflected light becomes large and the light receiving current signal becomes large in case of the short distance.

In the case of FIG. 18, according to the setting data of FIG. 16, the conversion gain is set to 50 kΩ, and the pulse width is set to 10 ns. Accordingly, the light intensity of emitted light is increased by increasing the pulse width of the laser beam, and further the conversion gain of TIA is increased. However, since the object exists at the long distance, the light receiving signal becomes an appropriate level, the light receiving signal exceeds the threshold, and the light receiving time Tcnt can be measured.

Since the light intensity of the laser beam is increased by increasing the pulse width of the laser beam, the light intensity of the reflected light from the object can be increased, SNR is improved, and a measurable distance can be increased. On the other hand, although the distance measurement resolution and the distance measurement precision deteriorate, the detection performance of the long distance object which is required when the moving speed of the moving body is high-speed can be improved. Moreover, in the case of the long distance object, since the capability of detecting itself is important, and the requirement to the distance measurement resolution and the distance measurement precision is low, deterioration of the distance measurement resolution and the distance measurement precision does not become a problem substantially. In the case where the moving speed of the moving body is the low speed, although the detection range may be the short distance, it is necessary to increase the distance measurement resolution and the distance measurement precision. In this case, the distance measurement resolution and the distance measurement precision can be improved by reducing the pulse width of the laser beam in exchange for reducing the measurable distance. Since the effectual light intensity of the laser beam is reduced by reducing the pulse width of the laser beam, the influence of internal dispersion after emission is reduced in exchange for reducing the measurable distance, and it becomes possible to expand the measurable range on the short distance side.

### Other Embodiments

Lastly, other embodiments of the present disclosure will be explained. Each of the configurations of embodiments to be explained below is not limited to be separately utilized but can be utilized in combination with the configurations of other embodiments as long as no discrepancy occurs.

(1) In the above Embodiment 1, as similar to Embodiment 2, the distance calculation unit 15 may change the pulse width of the laser beam which is emitted from the laser beam generating unit 11 (the laser beam source 111), based on the object distance and the moving speed of the moving body. In this case, the distance calculation unit 15 may increase the pulse width as the object distance becomes large, and increase the pulse width as the moving speed of the moving body becomes large.

(2) In the above Embodiment 2, there has been explained the case where the distance calculation unit 15 changes both of the conversion gain and the pulse width. However, the distance calculation unit 15 may change one of the conversion gain and the pulse width.

(3) In each of above embodiments, the laser distance measuring apparatus 10 uses the moving speed information of the moving body. However, if this information includes not only the running information at that time point but also “the running information predicted in future”, the capability of the collision avoidance to the object is further improved. For example, if it is expected that the moving speed is slowed down in future, the distance calculation unit 15 may set the object distance used for setting of the processing frequency, the conversion gain, and the pulse width, to the short distance side rather than the object distance at that time point. This causes a new effect that the safety of running increases. “The running information predicted in future” can be estimated from the acceleration of moving, and change of the running direction. In addition, it is also possible to utilize the will information from the driving body that operates the moving body. As the driving body, one or both of person and artificial intelligence can be considered. In addition to “the running information predicted in future”, the running information at that time point may be combined to be used.

(4) In each of above embodiments, there has been explained the case where the scanning mechanism 12 is provided with the MEMS mirror 121. For example, the scanning mechanism 12 may be provided with a rotary polygon mirror as the movable mirror, and may be provided with a mechanism that inclines a rotary shaft of the rotary polygon mirror so that the irradiation angle range of the up and down direction moves to the up side or the down side.

(5) In each of the above embodiments, there has been explained the case where the minute mirror is moved by Lorentz force. However, the movable mechanism of minute mirror is not limited to the electromagnetism method such as Lorentz force, and may be a piezo-electric method using a piezoelectric element, or an electrostatic method using an electrostatic force generated by a potential difference between the mirror and the electrode.

(6) In each of the above embodiments, there has been explained the case where the two-dimensional scan is performed by the scan as shown in FIG. 5 using the MEMS mirror 121. However, the two-dimensional scan may be performed by a Lissajous scan or a raster scan using the MEMS mirror 121; and a precessional scan may be performed using a sphere mirror.

(7) In each of the above embodiments, there has been explained the case where the two-dimensional scan is performed using the MEMS mirror 121 which rotates the mirror around two rotary shafts. However, the two-dimensional scan may be performed using two MEMS mirrors each of which rotates the mirror around one rotary shaft.

(8) In each of the above embodiments, there has been explained the case where the laser beam of the one laser beam source 111 is reflected by the MEMS mirror 121. However, the laser beams of plural laser beam sources 111 may be reflected by the MEMS mirror 121.

(9) In each of the above embodiments, there has been explained the case where the light detector 131 receives the reflected light L2 reflected by the MEMS mirror 121 and the collection mirror 133. However, the light detector 131 may receive directly the reflected light L2 reflected by the object.

(10) In each of the above embodiments, there has been explained the case where a type which transmits and receives pulsed light using the incoherent detection method is used. A type which transmits and receives pulsed light using a coherent detection method may be used. A type which transmits and receives the laser beam to which intensity modulation is performed by the sine wave may be used. It may be an incoherent FMCW (Frequency Modulated Continuous Waves) method. And, it may be a coherent FMCW method. If it is a type which transmits and receives a light which is performed intensity modulation by sine wave, modulation frequency of the sine wave is changed instead of changing the pulse width of the laser beam. If it is a type of the incoherent FMCW or the coherent FMCW, the sweep frequency width of modulation frequency is changed instead of changing the pulse width of the laser beam.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A laser distance measuring apparatus mounted on a moving body, comprising:
a laser beam generator that emits a laser beam;
a light receiver that receives a reflected light of the laser beam reflected by an object, and outputs a light receiving signal; and
a distance calculator that calculates an object distance which is a distance to the object, based on the emitted laser beam and the light receiving signal,
wherein the distance calculator changes a light receiving sensitivity of the light receiving signal, based on a moving speed of the moving body and the object distance.

2. The laser distance measuring apparatus according to claim 1,
wherein the distance calculator changes a processing frequency of the light receiving signals which are measured in this time and the past and used for calculation of the object distance, based on the object distance and the moving speed.

3. The laser distance measuring apparatus according to claim 2,
wherein the distance calculator increases the processing frequency as the object distance becomes large, and decreases the processing frequency as the moving speed becomes large.

4. The laser distance measuring apparatus according to claim 2, further comprising:
a scanning mechanism that change an irradiation angle of the laser beam, and
a scanning controller that controls the scanning mechanism to scan the irradiation angle of the laser beam periodically,
wherein the distance calculator calculates an integration value of the processing frequency of the light receiving signals which are measured in scanning periods of this time and the past at the same irradiation angle as this time, and calculates the object distance based on the integration value of the light receiving signals.

5. The laser distance measuring apparatus according to claim 2, further comprising:
a scanning mechanism that change an irradiation angle of the laser beam, and
a scanning controller that controls the scanning mechanism to scan the irradiation angle of the laser beam periodically,
wherein the distance calculator calculates an average value of the processing frequency of the light receiving signals which are measured in scanning periods of this time and the past at the same irradiation angle as this time, and calculates the object distance based on the average value of the light receiving signals.

6. The laser distance measuring apparatus according to claim 2, further comprising:
a scanning mechanism that change an irradiation angle of the laser beam, and
a scanning controller that controls the scanning mechanism to scan the irradiation angle of the laser beam periodically,
wherein the distance calculator calculates a maximum value of the processing frequency of the light receiving signals which are measured in scanning periods of this time and the past at the same irradiation angle as this time, and calculates the object distance based on the maximum value of the light receiving signals.

7. The laser distance measuring apparatus according to claim 4,
wherein the distance calculator shifts time of the light receiving signal measured in the past, by time corresponding to the object distance changed by moving of the moving body, and performs calculation processing of the object distance using the past light receiving signal whose time was shifted.

8. The laser distance measuring apparatus according to claim 5,
wherein the distance calculator shifts time of the light receiving signal measured in the past, by time corresponding to the object distance changed by moving of the moving body, and performs calculation processing of the object distance using the past light receiving signal whose time was shifted.

9. The laser distance measuring apparatus according to claim 6,
wherein the distance calculator shifts time of the light receiving signal measured in the past, by time corresponding to the object distance changed by moving of the moving body, and performs calculation processing of the object distance using the past light receiving signal whose time was shifted.

10. The laser distance measuring apparatus according to claim 1,
wherein the light receiver has a gain change circuit which changes a conversion gain from an output signal of a photo detector to the light receiving signal, and
Wherein the distance calculator changes the conversion gain, based on the object distance and the moving speed.

11. The laser distance measuring apparatus according to claim 10,
wherein the distance calculator increases the conversion gain as the object distance becomes large, and increases the conversion gain as the moving speed becomes large.

12. The laser distance measuring apparatus according to claim 1,
wherein the distance calculator changes a pulse width of the laser beam which is emitted from the laser beam generator, based on the object distance and the moving speed.

13. The laser distance measuring apparatus according to claim 12,
wherein the distance calculator increases the pulse width as the object distance becomes large, and increases the pulse width as the moving speed becomes large.
